(19) United States
(12) Patent Application Publication
(10) Pub. No.: US 2026/0329625 A1
(43) Pub. Date: Oct. 22, 2026

(54) DATA PROCESSING METHOD AND APPARATUS, DEVICE, AND STORAGE MEDIUM

(71) Applicant: Suzhou MetaBrain Intelligent Technology Co., Ltd., Suzhou, Jiangsu (CN)

(72) Inventors: Wei LIU, Suzhou, Jiangsu (CN); Yanmei SHEN, Suzhou, Jiangsu (CN); Dongdong SU, Suzhou, Jiangsu (CN)

(21) Appl. No.: 19/115,834

(22) PCT Filed: Sep. 4, 2024
(86) PCT No.: PCT/CN2024/116955

§ 371 Date: Mar. 27, 2025

(30) Foreign Application Priority Data
Sep. 6, 2023 (CN) 202311141816.1

(51) Int. Cl. G06F 9/48

(52) U.S. Cl. CPC G06F 9/4843

(57) ABSTRACT

The present application relates to the technical field of computers and discloses a data processing method and apparatus, a device, and a storage medium. The data processing method is applied to a computing server and includes: issuing a target computing task to a computing device through the computing server; receiving feedback information reported by the computing device based on the target computing task, the feedback information including a first storage address configured for storing the to-be-computed source data and a second storage address configured for storing computed result data; storing the to-be-computed source data in the first storage address based on the feedback information to cause the computing device to perform data computation based on the to-be-computed source data; and reading, when receiving computation completion information reported by the computing device based on the to-be-computed source data, the computed result data from the second storage address.

### CROSS-REFERENCE TO RELATED APPLICATIONS

This application claims priority to Chinese Patent Application No. 202311141816.1, filed on Sep. 6, 2023 in China National Intellectual Property Administration and entitled “Data Processing Method and Apparatus, Device, and Storage Medium”, which is hereby incorporated by reference in its entirety.

### FIELD

The present application relates to the technical field of computers, and particularly to a data processing method and apparatus, a device, and a storage medium.

### BACKGROUND

In the continuous development of artificial intelligence (AI), computing resources of graphics processing units (GPUs) have become an indispensable infrastructure for AI computing. To enhance the computing power and flexibility of the GPU, a network and other auxiliary modules (such as a field-programmable gate array) are usually used to connect the host and the GPU, making the GPU more independent from the host and thereby achieving better scalability and flexibility. However, if all operations on the GPU are performed on the device itself, it is generally necessary to place a central processing unit (CPU) on the device and then run the operating system on the CPU. However, this solution requires high performance of the GPU, and even if a high-performance GPU is used, the processing of network data packets by the host may significantly increase the latency during data transferring, thereby affecting the overall computational performance of the system.

### SUMMARY

In a first aspect, the present application provides a data processing method, including:
issuing a target computing task to a computing device through a computing server, the target computing task including resource occupation information of to-be-computed source data and a remote direct address access request;
receiving feedback information reported by the computing device based on the target computing task, the feedback information including a first storage address configured for storing the to-be-computed source data and a second storage address configured for storing computed result data which are allocated based on the remote direct address access request and the resource occupation information of the to-be-computed source data;
storing the to-be-computed source data in the first storage address based on the feedback information to cause the computing device to perform data computation based on the to-be-computed source data; and
reading, in response to receiving computation completion information reported by the computing device based on the to-be-computed source data, the computed result data from the second storage address.

In some optical implementations, generating the feedback information by the computing device includes:
acquiring a write request and a read request in the remote direct address access request;
allocating a data storage space and a result storage space to the to-be-computed source data based on the resource occupation information;
generating the first storage address based on the write request in the remote direct address access request and an address of the data storage space;
generating the second storage address based on the read request in the remote direct address access request and an address of the result storage space; and generating the feedback information based on the first storage address and the second storage address.

In some optical implementations, the computing server storing the to-be-computed source data in the first storage address based on the feedback information to cause the computing device to perform data computation based on the to-be-computed source data includes:
acquiring, by the computing server, the first storage address configured for storing the to-be-computed source data; and
writing, based on the first storage address, the to-be-computed source data into the data storage space allocated by the computing device, and generating a computation instruction to cause the computing device to perform data computation based on the to-be-computed source data.

In some optical implementations, the computing server storing the to-be-computed source data in the first storage address based on the feedback information further includes:
allocating, in response to the to-be-computed source data not being successfully stored in the first storage address allocated by the computing device, a first memory area with contiguous physical addresses in the computing server to the to-be-computed source data; and
issuing first address information of the first memory area to the computing device to cause the computing device to read the to-be-computed source data from the first memory area of the computing server based on the first address information and perform computation.

In some optical implementations, the computing device further includes a first cache space, and the computing device reading the to-be-computed source data from the first memory area of the computing server based on the first address information includes:
generating, by the computing device, a reading request based on the first address information to request to copy the to-be-computed source data read from the computing server into the first cache space; and
writing the to-be-computed source data in the first cache space into the data storage space based on the first storage address.

In some optical implementations, the computing device further includes a second cache space, and the copying the to-be-computed source data read into the first cache space further includes:
copying, in response to space capacity of the first cache space in the computing device being insufficient, the to-be-computed source data into the second cache space; and
writing the to-be-computed source data in the second cache space in the computing device into the data storage space based on the first storage address.

In some optical implementations, the computing server reading the computed result data from the second storage address includes:
acquiring the second storage address when the computation completion information reported by the computing device is received within a preset time; and
reading, based on the second storage address, the computed result data from the result storage space allocated by the computing device.

In some optical implementations, the computing server reading the computed result data from the second storage address further includes:
allocating, in response to the computing server failing to receive the computation completion information reported by the computing device based on the to-be-computed source data within a preset time or failing to read the computed result data, a second memory area with contiguous physical addresses in the computing server to the computed result data; and
issuing second address information of the second memory area to the computing device to cause the computing device to write the computed result data into the second memory area of the computing server based on the second address information.

In some optical implementations, the computing device writing the computed result data into the second memory area based on the second address information includes:
generating, by the computing device, a writing request based on the second address information to request to cache the computed result data read from the result storage space in the first cache space; and
writing the computed result data in the first cache space in the computing device into the second memory area based on the second address information.

In some optical implementations, the caching the computed result data read from the result storage space in the first cache space further includes:
caching, in response to the space capacity of the first cache space in the computing device being insufficient, the computed result data in the second cache space; and
writing the computed result data in the second cache space in the computing device into the second memory area of the computing server based on the second address information.

In some optical implementations, writing the to-be-computed source data in the first cache space and/or the second cache space in the computing device into the data storage space based on the first storage address includes:
acquiring a data volume of the to-be-computed source data in the first cache space and/or the second cache space in the computing device; and
writing, in response to the data volume of the to-be-computed source data being greater than a first data volume threshold, the to-be-computed source data in the first cache space and/or the second cache space into the data storage space based on the first storage address.

In some optical implementations, writing the computed result data in the first cache space and/or the second cache space in the computing device into the second memory area based on the second address information includes:
acquiring a data volume of the computed result data in the first cache space and/or the second cache space in the computing device; and
writing, in response to the data volume of the computed result data being greater than a second data volume threshold, the computed result data in the first cache space and/or second cache space into the second memory area based on the second address information.

In some optical implementations, the method further includes:
determining next cache states of the first cache space and the second cache space based on a request type, the request type including a writing request and the reading request; and
determining a result writing path of the computed result data and a data output path of the to-be-computed source data based on the next cache states,
where the result writing path includes a first result writing path from the result storage space to the first cache space and/or the second cache space, and a second result writing path from the first cache space and/or the second cache space to a second memory space; and
the data output path includes a first data output path from the first memory area to the first cache space and/or the second cache space, and a second data output path from the first cache space and/or the second cache space to the data storage space.

In some optical implementations, the determining next cache states of the first cache space and the second cache space based on a request type includes:
determining whether the next cache states of the first cache space and the second cache space are full states based on a writable space of the first cache space and the second cache space as well as the request type; and
determining whether the next cache states of the first cache space and the second cache space are empty states based on to-be-computed source data and computed result data which are able to be outputted from the first cache space and the second cache space as well as the request type.

In some optical implementations, before the computing server issues the computing task to the computing device, the method further includes:
receiving, by the computing server, a connection request initiated by the computing device, and starting a target computing program according to the connection request; and
establishing a connection between the computing server and the computing device through the target computing program.

In some optical implementations, the computing server stores a task cluster, and the computing server issuing the target computing task to the computing device includes:
acquiring computing states of computing tasks in the task cluster; and
issuing the target computing task to the computing device based on the computing states and idle resource state information carried in the connection request.

In some optical implementations, the issuing the target computing task to the computing device based on the computing states and idle resource state information carried in the connection request includes:
selecting, based on the idle resource state information, a target computing task from computing tasks in a to-be-computed state;
acquiring resource occupation information of to-be-computed source data in the target computing task; and
issuing the target computing task to the computing device based on the resource occupation information.

In a second aspect, the present application provides a data processing apparatus, applied to a computing server. The apparatus mainly includes: a task issuing module, an information feedback module, a data storage module, and a data reading module;
the task issuing module is configured to issue a target computing task to a computing device through a computing server, the target computing task including resource occupation information of to-be-computed source data and a remote direct address access request;
the information feedback module is configured to receive feedback information reported by the computing device based on the target computing task, the feedback information including a first storage address configured for storing the to-be-computed source data and a second storage address configured for storing computed result data which are allocated based on the remote direct address access request and the resource occupation information of the to-be-computed source data;
the data storage module is configured to store the to-be-computed source data in the first storage address based on the feedback information to cause the computing device to perform data computation based on the to-be-computed source data;
the data reading module is configured to read, in response to receiving computation completion information reported by the computing device based on the to-be-computed source data, the computed result data from the second storage address.

In a third aspect, the present application provides a data processing system, including: a computing server and a computing device;
the computing server is configured to issue a target computing task to the computing device, the target computing task including resource occupation information of to-be-computed source data and a remote direct address access request;
the computing device is configured to report feedback information based on the target computing task, the feedback information including a first storage address configured for storing the to-be-computed source data and a second storage address configured for storing computed result data which are allocated based on the remote direct address access request and the resource occupation information of the to-be-computed source data;
the computing server is further configured to store the to-be-computed source data in the first storage address based on the feedback information, and read, in response to receiving computation completion information reported by the computing device based on the to-be-computed source data, the computed result data from the second storage address.

In some optical implementations, the computing device further includes:
an autonomous forwarding module configured to write the to-be-computed source data into a data storage space corresponding to the first storage address based on link information carried in the remote direct address access request,
the autonomous forwarding module being further configured to acquire the computed result data in a result storage space corresponding to the second storage address, and write the computed result data into the computing server based on the link information carried in the remote direct address access request.

In a fourth aspect, the present application provides a computer device, including: a memory and a processor, the memory and the processor being communicatively connected to each other, the memory storing a computer-readable instruction, and the processor executing the computer-readable instruction to perform the data processing method of the above-mentioned first aspect or any one of its corresponding implementations.

In a fifth aspect, the present application provides one or more non-volatile computer-readable storage media, storing a computer-readable instruction which, when executed by one or more processors, performs the data processing method of the above-mentioned first aspect or any one of its corresponding implementations.

### BRIEF DESCRIPTION OF THE DRAWINGS

To more clearly illustrate the technical solutions in the specific implementations of the present application or in the related art, the drawings required in the descriptions of the specific implementations or the related art will be briefly introduced below. Obviously, the drawings described below are only some implementations of the present application, and a person skilled in the art may obtain other drawings according to these drawings without involving any inventive effort.

FIG. 1 is a schematic diagram of an application environment according to one or more embodiments of the present application;

FIG. 2 is a schematic flowchart of a data processing method according to one or more embodiments of the present application;

FIG. 3 is a schematic flowchart of another data processing method according to one or more embodiments of the present application;

FIG. 4 is a schematic flowchart of yet another data processing method according to one or more embodiments of the present application;

FIG. 5 is a schematic flowchart of still another data processing method according to one or more embodiments of the present application;

FIG. 6 is a data stream diagram according to one or more embodiments of the present application;

FIG. 7 is another data stream diagram according to one or more embodiments of the present application;

FIG. 8 is a block diagram of a structure of a data processing apparatus according to one or more embodiments of the present application; and

FIG. 9 is a schematic diagram of a hardware structure of a computer device according to one or more embodiments of the present application.

### DETAILED DESCRIPTION

To make the object, technical solutions, and advantages of the embodiments the present application clearer, the technical solutions in the embodiments of the present application will be clearly and completely described below in conjunction with the accompanying drawings in the embodiments of the present application. Obviously, the described embodiments are only some embodiments of the present application, not all embodiments. All other embodiments obtained by a person skilled in the art based on the embodiments in the present application without inventive efforts fall within the scope of the present application.

The terms “first” and “second” in the description and claims of the present application and in the foregoing figures are used for distinguishing different objects and not necessarily for describing a particular order. In addition, the term “comprise” and any variations thereof are intended to cover non-exclusive inclusions. For example, a process, method, system, product, or device containing a series of steps or units is not limited to the listed steps or units, but optionally also includes steps or units that are not listed, or optionally also includes other steps or units that are inherent to the process, method, product, or device. “A plurality of” in the present application may represent at least two, for example, two, three, or more, and the embodiments of the present application are not limited thereto.

Referring to FIG. 1, FIG. 1 is a schematic diagram of an application environment provided by an embodiment of the present application. In the schematic diagram, a computing device 100 is included, which may include a field-programmable gate array 101 and a GPU 102. The GPU 102 is configured to compute and store data, and the field-programmable gate array is configured to forward the computed data. The computing device 100 may be communicatively connected to the computing server 200 through a network 300, and a database 201 may be provided on or separate from the computing server 200 to provide data storage services to the computing server 200. In addition, the computing server 200 may have a processing engine 202 running therein, and the processing engine 202 may be configured to perform steps performed by the computing server 200.

Optically, the computing device 100 may be, but is not limited to, a terminal capable of computing data, such as a mobile terminal (e.g., a tablet computer), a notebook computer, and a personal computer (PC). The above-mentioned network may include, but is not limited to, a wireless network or a wired network. The wireless network includes: Bluetooth, wireless fidelity (WIFI), remote direct address access, and other networks that enable wireless communications. The above-mentioned wired network may include, but is not limited to: a wide area network, a metropolitan area network, and a server cluster. The above-mentioned computing server 200 may include, but is not limited to, any hardware device capable of performing computation.

In addition, in this embodiment, the above-mentioned data processing method may also be applied to, but is not limited to, an independent processing device with a relatively strong processing capability, without the need for data interaction. For example, the processing device may be, but is not limited to, a terminal device with a relatively strong processing capability. That is, the operations in the above-mentioned data processing method may be integrated into an independent processing device. The foregoing is merely an example and is not intended to be limiting in any way in this embodiment.

Optically, in this embodiment, the above-mentioned data processing method may be performed by the computing server 200, by the computing device 100, or by both the computing server 200 and computing device 100. The data processing method of the embodiment of the present application performed by the computing device 100 may also be performed by a client installed on the computing device 100.

According to the embodiments of the present application, a data processing method embodiment is provided. It should be noted that the steps illustrated in the flowcharts of the figures may be performed in a computer system, such as a set of computer-executable instructions. In addition, although logical orders are illustrated in the flowcharts, in some cases, the steps illustrated or described may be performed in an order different from those presented here.

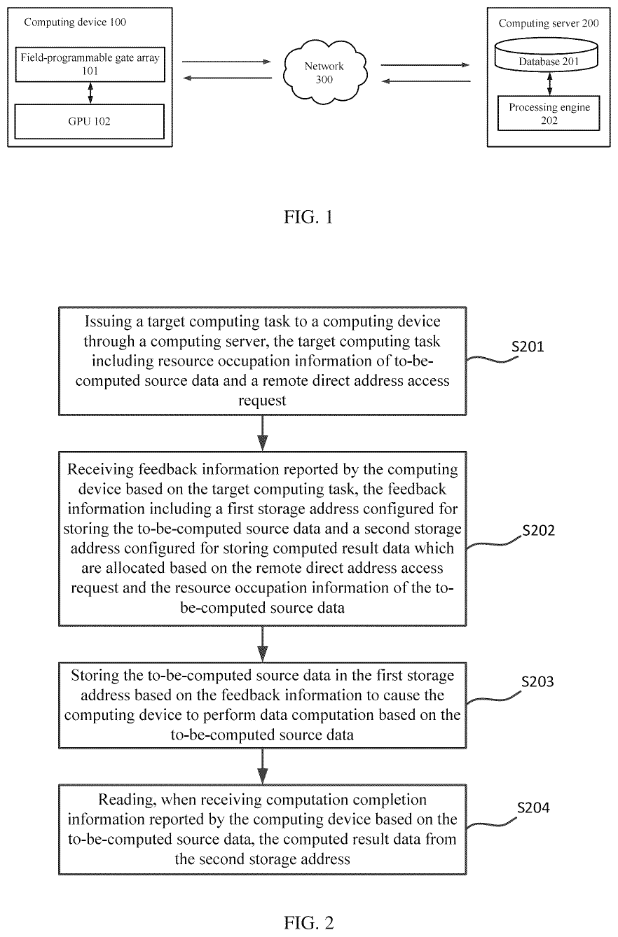

In this embodiment, a data processing method is provided, which may be applied to the above-mentioned computing server. FIG. 2 is a flowchart of a data processing method according to an embodiment of the present application. As shown in FIG. 2, the flowchart includes the following steps.

At S201, a target computing task is issued to a computing device through a computing server, the target computing task including resource occupation information of to-be-computed source data and a remote direct address access request.

As described above, the target computing task is issued to the computing device through the computing server, so as to inform the computing device of the resource occupation information of the to-be-computed source data for data computation, and meanwhile, direct access to a memory between the computing device and the computing server is established based on the remote direct address access request. The to-be-computed source data may include a computation model, a data volume, and the number of computations.

In some optical implementations, the computing server stores a task cluster. Firstly, the computing server may receive a connection request initiated by the computing device and start a target computing program according to the connection request, establish a connection between the computing server and the computing device through the target computing program, then acquire computing states of computing tasks in the task cluster, and issue the target computing task to the computing device based on the computing states and idle resource state information carried in the connection request.

For example, first, when receiving the connection request initiated by the computing device through a socket, the computing server starts the target computing program, such as an AI computing program, according to the connection request, and then establishes a network connection between the computing server and the computing device through the AI computing program. In this case, the computing server acquires the computing states of the computing tasks stored therein, and issues the target computing task to the computing device according to the computing states of the computing tasks and the idle resource state information carried in the connection request.

In some optical implementations, when the target computing task is issued to the computing device based on the computing states and the idle resource state information carried in the connection request, the target computing task may be selected from computing tasks in a to-be-computed state based on the idle resource state information, the resource occupation information of the to-be-computed source data in the target computing task may be acquired, and the target computing task may be issued to the computing device based on the resource occupation information.

For example, when the target computing task is issued to the computing device, the amount of idle resources carried in the idle resource state information may be acquired first. Then, the computing tasks in the to-be-computed state are sorted according to the resource occupation information, and the resource occupation information is traversed based on the amount of idle resources, so as to select the target computing task from the computing tasks in the to-be-computed state. Finally, the target computing task is issued to the computing device based on the resource occupation information of the to-be-computed source data in the target computing task.

At S202, feedback information reported by the computing device based on the target computing task is received, the feedback information including a first storage address configured for storing the to-be-computed source data and a second storage address configured for storing computed result data which are allocated based on the remote direct address access request and the resource occupation information of the to-be-computed source data.

As described above, the feedback information of the first storage address configured for storing the to-be-computed source data and the second storage address configured for storing the computed result data reported by the computing device based on the target computing task is received to facilitate writing the to-be-computed source data and directly reading the computed result data.

In some optical implementations, when generating the feedback information, the computing device may first acquire a write request and a read request in the remote direct address access request, allocate a data storage space and a result storage space to the to-be-computed source data based on the resource occupation information, generate the first storage address based on the write request in the remote direct address access request and an address of the data storage space, generate the second storage address based on the read request in the remote direct address access request and an address of the result storage space; and generate the feedback information based on the first storage address and the second storage address.

Specifically, when receiving a computing task issued by the computing server, the computing device first allocates a corresponding computing resource and a corresponding memory space, such as the data storage space and the result storage space, to the to-be-computed source data according to the resource occupation information of the to-be-computed source data. Meanwhile, the first storage address is generated based on the write request in the remote direct address access request and the address of the data storage space, whereby the computing server may directly write the to-be-computed source data according to the first storage address. The second storage address is generated based on the read request in the remote direct address access request and the address of the result storage space, whereby the computing server may directly read the computed result data into its own memory according to the second storage address, thereby saving the time consumption of data copying.

At S203, the to-be-computed source data is stored in the first storage address based on the feedback information to cause the computing device to perform data computation based on the to-be-computed source data.

As described above, the to-be-computed source data is stored in the first storage address based on the feedback information, whereby one data copying-like operation is saved, the data transmission efficiency may be improved greatly, and the overall operational performance of the system may be improved.

In some optical implementations, the to-be-computed source data is stored in the first storage address based on the feedback information, whereby when the computing device performs data computation based on the to-be-computed source data, the computing server first acquires the first storage address of the data storage space configured for storing the to-be-computed source data according to the feedback information, then directly accesses the first storage address through a remote address so as to write the to-be-computed source data into the data storage space, and meanwhile, generates a computation instruction to inform the computing device that the to-be-computed source data has been written, and to cause the computing device to perform data computation based on the to-be-computed source data.

At S204, when receiving computation completion information reported by the computing device based on the to-be-computed source data, the computed result data is read from the second storage address.

As described above, when receiving the computation completion information reported by the computing device, the computed result data is read from the second storage address, whereby one data copying-like operation is saved, the data transmission efficiency may be further improved greatly, and the overall operational performance of the system may be improved.

In some optical implementations, if the computation completion information reported by the computing device based on the to-be-computed source data is received within a preset time, the second storage address in the feedback information is acquired. Then, the second storage address is accessed directly through the remote address, thereby reading the computed result data directly from the result storage space. Before receiving the computation completion information reported by the computing device, the computing service device may be in a busy-waiting state.

Through the above-mentioned processes, the to-be-computed source data in the computing server may be directly written into the memory of the computing device, thereby saving one data copying-like operation. In addition, the computed result data is directly read from the memory of the computing device into a host memory of the computing server, whereby one data copying-like operation is saved again, the data transmission efficiency may be improved greatly, and the overall operational performance of the system may be improved.

According to the data processing method provided in this embodiment, the target computing task is issued to the computing device through the computing server, so as to inform the computing device of the resource occupation information of the to-be-computed source data for data computation, and meanwhile, the direct access to the memory between the computing device and the computing server is established based on the remote direct address access request. The feedback information of the first storage address configured for storing the to-be-computed source data and the second storage address configured for storing the computed result data reported by the computing device based on the target computing task is received to facilitate writing the to-be-computed source data and directly reading the computed result data. The to-be-computed source data is stored in the first storage address based on the feedback information, whereby one data copying-like operation is saved, the data transmission efficiency may be improved greatly, and the overall operational performance of the system may be improved. When receiving the computation completion information reported by the computing device, the computed result data is read from the second storage address, whereby one data copying-like operation is saved, the data transmission efficiency may be further improved greatly, and the overall operational performance of the system may be improved.

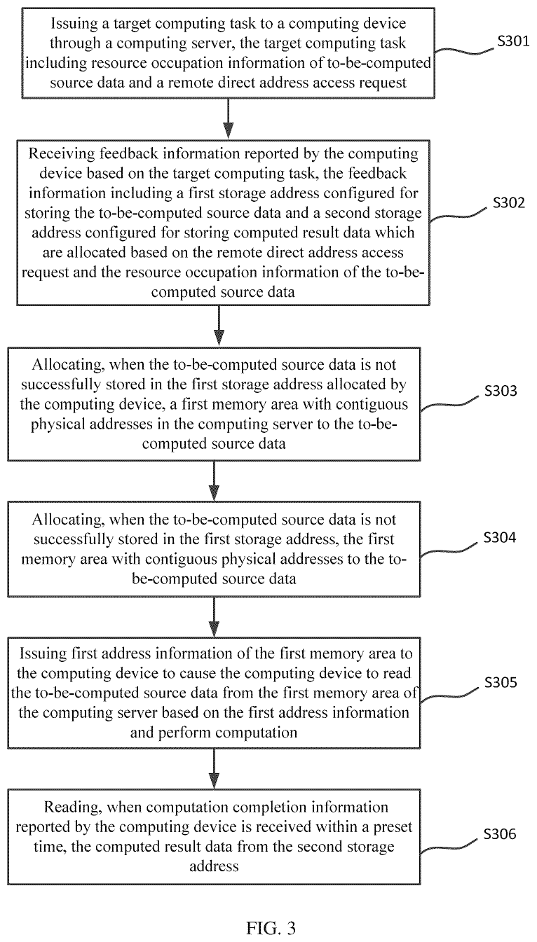

In this embodiment, a data processing method is provided, which may be applied to the above-mentioned computing server. FIG. 3 is a flowchart of a data processing method according to an embodiment of the present application. As shown in FIG. 3, the flowchart includes the following steps.

At S301, a target computing task is issued to a computing device through a computing server, the target computing task including resource occupation information of to-be-computed source data and a remote direct address access request.

As described above, the target computing task is issued to the computing device through the computing server, so as to inform the computing device of the resource occupation information of the to-be-computed source data for data computation, and meanwhile, direct access to a memory between the computing device and the computing server is established based on the remote direct address access request. The to-be-computed source data may include a computation model, a data volume, and the number of computations.

Detailed description may refer to S201 in the embodiment shown in FIG. 2, which will not be repeated here.

At S302, feedback information reported by the computing device based on the target computing task is received, the feedback information including a first storage address configured for storing the to-be-computed source data and a second storage address configured for storing computed result data which are allocated based on the remote direct address access request and the resource occupation information of the to-be-computed source data.

As described above, the feedback information of the first storage address configured for storing the to-be-computed source data and the second storage address configured for storing the computed result data reported by the computing device based on the target computing task is received to facilitate writing the to-be-computed source data and directly reading the computed result data through remote direct address access request.

Detailed description may refer to S202 in the embodiment shown in FIG. 2, which will not be repeated here.

At S303, the to-be-computed source data is stored in the first storage address based on the feedback information.

As described above, the to-be-computed source data is stored in the first storage address based on the feedback information, whereby one data copying-like operation is saved, the data transmission efficiency may be improved greatly, and the overall operational performance of the system may be improved.

Detailed description may refer to S203 in the embodiment shown in FIG. 2, which will not be repeated here.

At S304, when the to-be-computed source data is not successfully stored in the first storage address allocated by the computing device, a first memory area with contiguous physical addresses is allocated in the computing server to the to-be-computed source data.

As described above, if the to-be-computed source data is not successfully stored in the first storage address allocated by the computing device, the first memory area with contiguous physical addresses is allocated in the computing server to the to-be-computed source data, whereby the computing device can actively read the to-be-computed source data, i.e., directly accessing a memory of the computing server.

In some optical implementations, when storing the to-be-computed source data in the data storage space based on the first storage address, the computing server monitors a writing state of the to-be-computed source data into the data storage space, and when the to-be-computed source data is not written completely, the written data is incomplete, or the written data is erroneous within a threshold time, determines that the to-be-computed source data is not successfully stored in the first storage address. In this case, to enable the normal operation of the target computing task, the first memory area with contiguous physical addresses is allocated on the computing server to the to-be-computed source data. It will be appreciated that the first memory area may include a plurality of areas of contiguous physical addresses.

At S305, first address information of the first memory area is issued to the computing device to cause the computing device to read the to-be-computed source data from the first memory area of the computing server based on the first address information and perform computation.

As described above, the first address information of the first memory area is issued to the computing device, whereby the computing device can actively read and compute the to-be-computed source data in the case where the computing server fails to write the to-be-computed source data.

In some optical implementations, in order to realize that an image processor of the computing device directly accesses the memory of the computing server through PCIe using a remote address, or when the image processor of the computing device cannot directly access the memory of the computing server, a field-programmable gate array of the computing device is further configured with a first cache space and a second cache space. When the to-be-computed source data is not successfully stored in the first storage address, the computing device generates a reading request based on the first address information to request to copy the to-be-computed source data read from the computing server into the first cache space, and then writes the to-be-computed source data in the first cache space into the data storage space based on the first storage address, i.e., the forwarding of the to-be-computed source data is realized.

Specifically, when receiving the first address information of the first memory area with contiguous physical addresses allocated by the computing server, the computing device generates the reading request based on the first address information of the first memory area. The reading request is configured for reading the to-be-computed source data in the first memory area into a data storage space of a GPU in the computing device. However, since the GPU in the computing device cannot directly access the data storage space of the computing service through a remote address or needs to directly access the memory of the computing server through the PCIe, in this case, to avoid directly writing the to-be-computed source data into a memory of the field-programmable gate array and then forwarding the to-be-computed source data to the GPU via software, when the GPU in the computing device generates the reading request for the first address information and a target address of the reading request is the first memory area, the field-programmable gate array intercepts the reading request, copies the to-be-computed source data into the first cache space based on the reading request, and then writes the to-be-computed source data in the first cache space into the data storage space based on the first storage address.

In some optical implementations, when space capacity of the first cache space in the computing device is insufficient, the to-be-computed source data is copied into the second cache space, and the to-be-computed source data in the second cache space in the computing device is written into the data storage space based on the first storage address.

Specifically, when the to-be-computed source data in the first cache space and/or the second cache space in the computing device is written into the data storage space based on the first storage address, a data volume of the to-be-computed source data in the first cache space and/or the second cache space in the computing device may be acquired, and when the data volume of the to-be-computed source data is greater than a first data volume threshold, the to-be-computed source data in the first cache space and/or the second cache space is written into the data storage space based on the first storage address. In other embodiments, the to-be-computed source data in the first cache space and/or the second cache space may also be written to the data storage space based on the first storage address at intervals. It will be appreciated that collectively reading and writing the to-be-computed source data may reduce the overhead of the computing device and facilitate the computation of the read to-be-computed source data.

At S306, when computation completion information reported by the computing device is received within a preset time, the computed result data is read from the second storage address.

As described above, if receiving the computation completion information reported by the computing device within a preset time, the computing server read the computed result data from the second storage address, whereby one data copying-like operation is saved, the data transmission efficiency may be further improved greatly, and the overall operational performance of the system may be improved.

Detailed description may refer to S204 in the embodiment shown in FIG. 2, which will not be repeated here.

According to the data processing method provided in this embodiment, the target computing task is issued to the computing device through the computing server, so as to inform the computing device of the resource occupation information of the to-be-computed source data for data computation, and meanwhile, the direct access to the memory between the computing device and the computing server is established based on the remote direct address access request. The feedback information of the first storage address configured for storing the to-be-computed source data and the second storage address configured for storing the computed result data reported by the computing device based on the target computing task is received to facilitate writing the to-be-computed source data and directly reading the computed result data. The to-be-computed source data is stored in the first storage address based on the feedback information, whereby one data copying-like operation is saved, the data transmission efficiency may be improved greatly, and the overall operational performance of the system may be improved. If the to-be-computed source data is not successfully stored in the first storage address, the first memory area with contiguous physical addresses is allocated in the computing server to the to-be-computed source data, whereby the computing device can actively read the to-be-computed source data, i.e., directly accessing the memory of the computing server. The first address information of the first memory area is issued to the computing device, whereby the computing device can actively read the to-be-computed source data in the case where the computing server fails to write the to-be-computed source data. When receiving the computation completion information reported by the computing device within the preset time, the computed result data is read from the second storage address, whereby one data copying-like operation is saved, the data transmission efficiency may be further improved greatly, and the overall operational performance of the system may be improved.

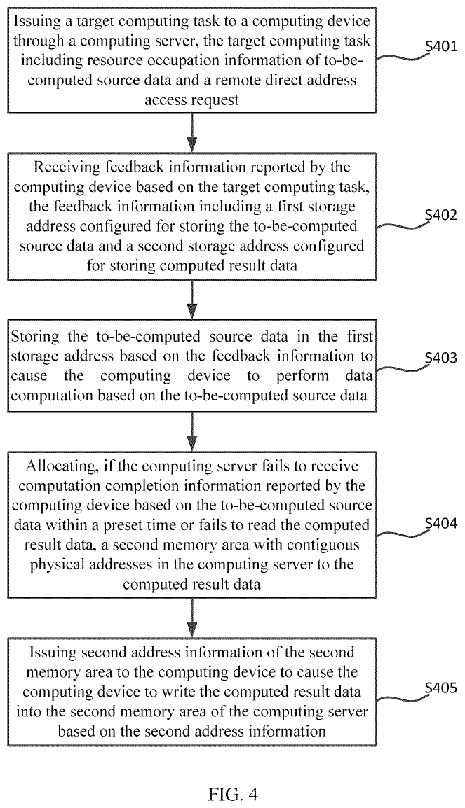

In this embodiment, a data processing method is provided, which may be applied to the above-mentioned computing server. FIG. 4 is a flowchart of a data processing method according to an embodiment of the present application. As shown in FIG. 4, the flowchart includes the following steps.

At S401, a target computing task is issued to a computing device through a computing server, the target computing task including resource occupation information of to-be-computed source data and a remote direct address access request.

As described above, the target computing task is issued to the computing device, so as to inform the computing device of the resource occupation information of the to-be-computed source data for data computation, and meanwhile, direct access to a memory between the computing device and the computing server is established based on the remote direct address access request. The to-be-computed source data may include a computation model, a data volume, and the number of computations.

Detailed description may refer to S201 in the embodiment shown in FIG. 2, which will not be repeated here.

At S402, feedback information reported by the computing device based on the target computing task is received, the feedback information including a first storage address configured for storing the to-be-computed source data and a second storage address configured for storing computed result data.

As described above, the feedback information of the first storage address configured for storing the to-be-computed source data and the second storage address configured for storing the computed result data reported by the computing device based on the target computing task is received to facilitate writing the to-be-computed source data and directly reading the computed result data.

Detailed description may refer to S202 in the embodiment shown in FIG. 2, which will not be repeated here.

At S403, the to-be-computed source data is stored in the first storage address based on the feedback information to cause the computing device to perform data computation based on the to-be-computed source data.

As described above, the to-be-computed source data is stored in the first storage address based on the feedback information, whereby one data copying-like operation is saved, the data transmission efficiency may be improved greatly, and the overall operational performance of the system may be improved.

Detailed description may refer to S203 in the embodiment shown in FIG. 2, which will not be repeated here.

At S404, if the computing server fails to receive the computation completion information reported by the computing device based on the to-be-computed source data within a preset time or fails to read the computed result data, a second memory area with contiguous physical addresses is allocated in the computing server to the computed result data.

As described above, if the computing server fails to receive the computation completion information reported by the computing device based on the to-be-computed source data within the preset time or fails to read the computed result data, the second memory area with contiguous physical addresses is allocated in the computing server to the computed result data, whereby the computing device can actively write the computed result data, i.e., directly accessing the memory of the computing server. Thus, one data copying-like operation is saved again, the data transmission efficiency may be improved greatly, and the overall operational performance of the system may be improved.

In some optical implementations, when reading the computed result data from the result storage space based on the second storage address, the computing server monitors the computation completion information and a reading state of the computed result data, and if the computation completion information reported by the computing device is not received within the preset time, or the computed result data cannot be read, determines that the computed result data fails to be read. In this case, to enable operation result data of the target computing task to be read normally, the second memory area with contiguous physical addresses is allocated on the computing server to the computed result data. It will be appreciated that the second memory area may include a plurality of areas of contiguous physical addresses.

At S405, second address information of the second memory area is issued to the computing device to cause the computing device to write the computed result data into the second memory area of the computing server based on the second address information.

As described above, the computing server issues the second address information of the second memory area to the computing device, whereby the computing device can actively write the computation result in the case where the computing server fails to read the computed result data.

In some optical implementations, when the computing device writes the computed result data into the second memory area based on the second address information, the computing device generates a writing request based on the second address information to request to cache the computed result data read from the result storage space in a first cache space, and then writes the computed result data in the first cache space in the computing device into the second memory area based on the second address information. When space capacity of the first cache space in the computing device is insufficient, the computed result data in the computing device is cached in a second cache space. The computed result data in the second cache space is written into the second memory area of the computing server based on the second address information.

Specifically, when receiving the second address information of the second memory area with contiguous physical addresses allocated by the computing server, the computing device generates the writing request based on the second address information of the second memory area. The writing request is configured for writing the computed result data in the result storage space into the second memory area of the computing server. However, since a GPU in the computing device cannot directly access the data storage space of the computing service through a remote address or needs to directly access the memory of the computing server through PCIe, in this case, to avoid directly writing the computed result data in the GPU into a memory of a field-programmable gate array and then forwarding the computed result data to the computing server via software, when the GPU in the computing device generates the writing request for the second address information and a target address of the writing request is the second memory area, the field-programmable gate array intercepts the writing request, temporarily caches the computed result data in a computation result space into the first cache space based on the writing request, and then writes the computed result data in the first cache space into the second memory area based on the second address information.

In some optical implementations, when writing the computed result data in the first cache space and/or the second cache space into the second memory area based on the second address information, the computing device may acquire a data volume of the computed result data in the first cache space and/or the second cache space, and when the data volume of the computed result data is greater than a second data volume threshold, write the computed result data in the first cache space and/or the second cache space into the second memory area of the computing server based on the second address information. In other embodiments, the computing device may also write the computed result data in the first cache space and/or the second cache space into the second storage area based on the first storage address at intervals. It will be appreciated that collectively writing the computed result data may reduce the overhead of the computing device.

According to the data processing method provided in this embodiment, the target computing task is issued to the computing device through the computing server, so as to inform the computing device of the resource occupation information of the to-be-computed source data for data computation, and meanwhile, the direct access to the memory between the computing device and the computing server is established based on the remote direct address access request. The feedback information of the first storage address configured for storing the to-be-computed source data and the second storage address configured for storing the computed result data reported by the computing device based on the target computing task is received to facilitate writing the to-be-computed source data and directly reading the computed result data. The to-be-computed source data is stored in the first storage address based on the feedback information, whereby one data copying-like operation is saved, the data transmission efficiency may be improved greatly, and the overall operational performance of the system may be improved. If the computation completion information reported by the computing device is not received within the preset time or the computed result data cannot be read, the second memory area with contiguous physical addresses is allocated to the computed result data, whereby the computing device can actively write the computed result data, i.e., directly accessing the memory of the computing server. Thus, one data copying-like operation is saved again. The second address information of the second memory area is issued to the computing device, whereby the computing device can actively write the computation result in the case where the computing server fails to read the computed result data.

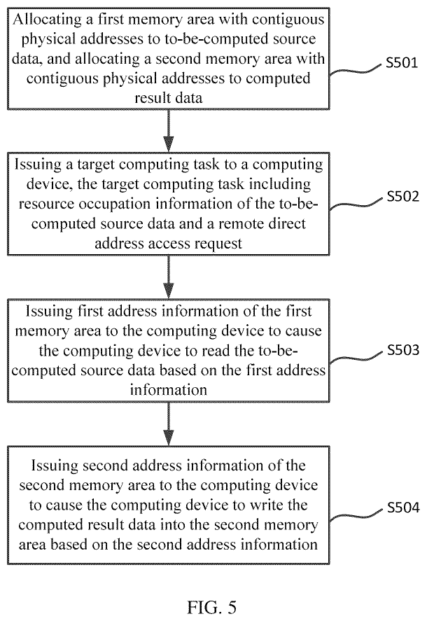

In this embodiment, a data processing method is provided, which may be applied to the above-mentioned computing server. FIG. 5 is a flowchart of a data processing method according to an embodiment of the present application. As shown in FIG. 5, the flowchart includes the following steps.

At S501, a first memory area with contiguous physical addresses is allocated to to-be-computed source data, and a second memory area with contiguous physical addresses is allocated to computed result data.

As described above, the first memory area with contiguous physical addresses is allocated to the to-be-computed source data, whereby the computing device can actively acquire the to-be-computed source data when receiving a target computing task. The second memory area with contiguous physical addresses is allocated to the computed result data, whereby the computing device can actively upload the computed result data when the computation is completed.

At S502, a target computing task is issued to a computing device, the target computing task including resource occupation information of the to-be-computed source data and a remote direct address access request.

As described above, the target computing task is issued to the computing device, so as to inform the computing device of the resource occupation information of the to-be-computed source data for data computation, and meanwhile, direct access to a memory between the computing device and the computing server is established based on the remote direct address access request. The to-be-computed source data may include a computation model, a data volume, and the number of computations.

Detailed description may refer to S201 in the embodiment shown in FIG. 2, which will not be repeated here.

At S503, first address information of the first memory area is issued to the computing device to cause the computing device to read the to-be-computed source data based on the first address information.

As described above, the first address information of the first memory area is issued to the computing device, whereby the computing device can actively read the to-be-computed source data in the case where the computing server fails to write the to-be-computed source data.

Detailed description may refer to S304 in the embodiment shown in FIG. 3, which will not be repeated here.

At S504, second address information of the second memory area is issued to the computing device to cause the computing device to write the computed result data into the second memory area based on the second address information.

As described above, the second memory area with contiguous physical addresses is allocated to the computed result data, whereby the computing device can actively write the computed result data, i.e., directly accessing the memory of the computing server. Thus, one data copying-like operation is saved again, the data transmission efficiency may be improved greatly, and the overall operational performance of the system may be improved.

In some optical implementations, when a result writing path of the computed result data and a data output path of the to-be-computed source data are determined, next cache states of a first cache space and a second cache space may be determined based on a request type. The request type includes a writing request and a reading request. The result writing path of the computed result data and the data output path of the to-be-computed source data are determined based on the next cache states. The result writing path includes a first result writing path from the result storage space to the first cache space and/or the second cache space, and a second result writing path from the first cache space and/or the second cache space to a second memory space. The data output path includes a first data output path from the first memory area to the first cache space and/or the second cache space, and a second data output path from the first cache space and/or the second cache space to the data storage space.

In some optical implementations, when the next cache states of the first cache space and the second cache space are determined based on the request type, it may be determined whether the next cache states of the first cache space and the second cache space are full states based on a writable space of the first cache space and the second cache space as well as the request type, and determined whether the next cache states of the first cache space and the second cache space are empty states based on to-be-computed source data and computed result data which are able to be outputted from the first cache space and the second cache space as well as the request type.

For example, when the request type is an output request, it is determined that the next cache state of the first cache space is a non-full state. When the request type is the writing request and a data volume of writable computed result data or to-be-computed source data is 1, it is determined that the next cache state of the first cache space is the full state. When neither the output request nor the writing request is received, it is determined that the next cache state of the first cache space does not change. In the process of determining the empty state, when the request type is the output request, it is determined that the next cache state of the first cache space is a non-empty state. When the request type is the output request and a data volume of computed result data or to-be-computed source data which are able to be outputted is 1, it is determined that the next cache state of the first cache space is the empty state. When neither the output request nor the writing request is received, it is determined that the next cache state of the first cache space does not change.

According to the data processing method provided in this embodiment, the first memory area with contiguous physical addresses is allocated to the to-be-computed source data, whereby the computing device can actively acquire the to-be-computed source data when receiving the target computing task. The second memory area with contiguous physical addresses is allocated to the computed result data, whereby the computing device can actively upload the computed result data when the computation is completed. The target computing task is issued to the computing device, so as to inform the computing device of the resource occupation information of the to-be-computed source data for data computation, and meanwhile, direct access to the memory between the computing device and the computing server is established based on the remote direct address access request. The first address information of the first memory area is issued to the computing device, whereby the computing device can actively read the to-be-computed source data in the case where the computing server fails to write the to-be-computed source data. The second memory area with contiguous physical addresses is allocated to the computed result data, whereby the computing device can actively write the computed result data, i.e., directly accessing the memory of the computing server. Thus, one data copying-like operation is saved again, the data transmission efficiency may be improved greatly, and the overall operational performance of the system may be improved.

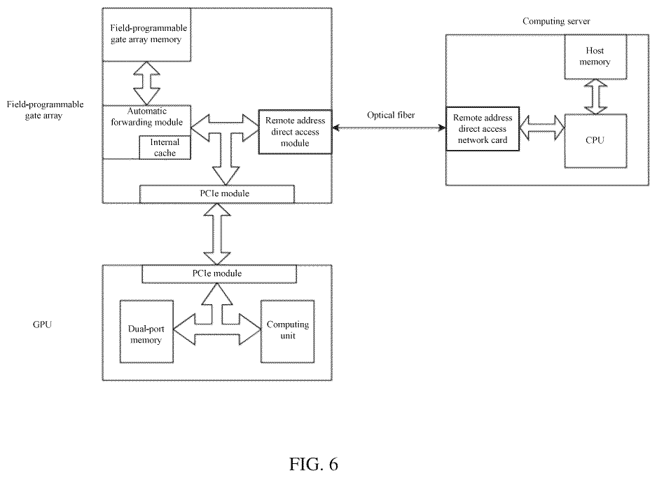

In the process of transferring the above-mentioned data (to-be-computed source data and computed result data), the data is directly written into or read out by the computing server through remote address direct access. However, in practical work, there are also cases where some types of field-programmable gate arrays do not support an external module or a CPU to directly access their dual-port memories. In this case, the field-programmable gate array needs to use direct memory access (DMA) to directly access a system memory (a field-programmable gate array memory in the case of a distributed device) through a bus. For a distributed computing device, to avoid data being written into the field-programmable gate array memory and then being forwarded to a host memory by a software-controlled remote address direct access module (because of the poor performance of this scene), it is necessary to support the field-programmable gate array to directly access the host memory through the DMA (plus other newly added logic and skipping software, avoiding the intervention of the CPU). In this scene, this embodiment further provides a data processing system. As shown in FIG. 6, the data processing system includes a computing server and a computing device. The computing server is configured to issue a target computing task to the computing device, the target computing task including resource occupation information of to-be-computed source data and a remote direct address access request. The computing device is configured to report feedback information based on the target computing task, the feedback information including a first storage address configured for storing the to-be-computed source data and a second storage address configured for storing computed result data which are allocated based on the remote direct address access request and the resource occupation information of the to-be-computed source data. The computing server is further configured to store the to-be-computed source data in the first storage address based on the feedback information, and read, when receiving computation completion information reported by the computing device based on the to-be-computed source data, the computed result data from the second storage address. The computing device further includes: an autonomous forwarding module configured to write the to-be-computed source data into a data storage space corresponding to the first storage address based on link information carried in the remote direct address access request. The autonomous forwarding module is further configured to acquire the computed result data in a result storage space corresponding to the second storage address, and write the computed result data into the computing server based on the link information carried in the remote direct address access request.

Specifically, the computing device includes a GPU and a field-programmable gate array connected to the GPU. The computing server includes a CPU, and the host includes a CPU, and a host memory and a remote address direct access network card connected to the CPU. The field-programmable gate array includes an automatic forwarding module, where the automatic forwarding module can perform internal cache remote address direct access (first cache space), and the field-programmable gate array memory (second cache space) and a remote address direct access module connected to the automatic forwarding module. The remote address direct access module is connected to the remote address direct access network card. The GPU includes a dual-port memory and a computing unit, and the GPU communicates with the field-programmable gate array through a bus (PCIe module).

Taking supporting the GPU to perform a DMA write operation as an example, the specific working process is as follows.
(1) The software on the computing server requests a memory area (second memory area) with contiguous physical addresses for the image processor to access and informs software running on a soft core of the field-programmable gate array of a starting address and a length of this memory.
(2) The software running on the soft core of the field-programmable gate array configures the address of the host memory in step (1) to the image processor and the automatic forwarding module, and the image processor accesses this address as an ordinary host memory.
(3) The image processor starts to write the computed result data into the above-mentioned memory area through a DMA operation.
(4) The automatic forwarding module captures the address (belonging to the address range already configured in step (2)) and data signals of the memory accessing behavior sent by the image processor (in a DMA manner) via the bus.
(5) The automatic forwarding module temporarily caches the computed result data into its own internal cache (first cache space), and when the space is insufficient, a memory (second cache space) on a field-programmable gate array board may be used.
(6) The automatic forwarding module accesses the remote address direct access module and writes the computed result data into a corresponding address (second address information) of the host memory (second memory area) through a remote address direct access write operation.

For a scene in which the image processor directly reads the host memory through the DMA, the working process is as follows.
(1) The software on the host requests a memory area (first memory area) with contiguous physical addresses for the image processor to access and informs software running on a soft core of the field-programmable gate array of a starting address and a length of this memory.
(2) The software running on the soft core of the field-programmable gate array configures the address of the host memory in step (1) to the image processor and the automatic forwarding module, and the image processor accesses this address as an ordinary host memory.
(3) The image processor starts to read the to-be-computed source data from the above-mentioned memory area through a DMA read operation.
(4) The automatic forwarding module captures the address (belonging to the address range already configured in step (2)) and data signals of the memory reading behavior sent by the image processor (in a DMA manner) via the bus, but temporarily does not give any reply to the image processor.
(5) The automatic forwarding module accesses the remote address direct access module and copies to-be-computed source data from the corresponding address of the host memory into the internal cache (first cache space) through a remote address direct access read operation. When the space is insufficient, the memory (second cache space) on the field-programmable gate array board may be used.
(6) The automatic forwarding module starts to reply to the image processor's DMA reading behavior by sending a bus message, and meanwhile, transfers the to-be-computed source data to the image processor.

It will be appreciated that there is no notification (i.e., network data transmission or reception) behavior between the application programs of the computing server and the computing device, which can save a certain amount of computation time.

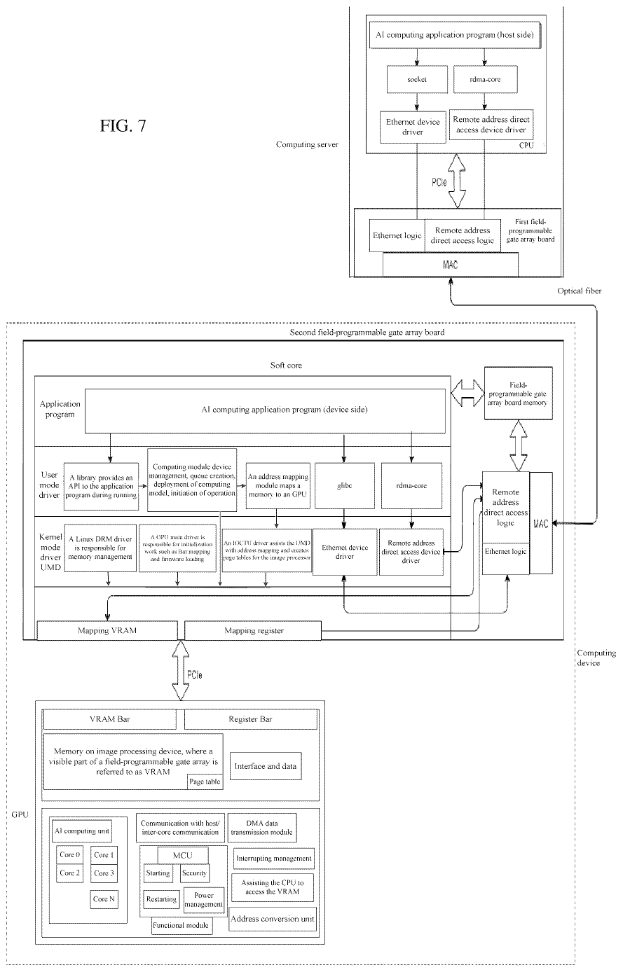

Referring to FIG. 7, a data stream diagram of a computing device and a computing server in a data processing system is shown. The computing server host includes a CPU and a first field-programmable gate array board connected to the CPU through PCIe. The first field-programmable gate array board supports Ethernet logic and remote address direct access logic. The computing device also includes a second field-programmable gate array board and an image processor connected through PCIe. The second field-programmable gate array board supports Ethernet logic and remote address direct access logic. That is, the second field-programmable gate array board interacts with the first field-programmable gate array board through the Ethernet logic and the remote address direct access logic. The second field-programmable gate array board is further provided with a soft core and a field-programmable gate array board memory that interact with each other, and the field-programmable gate array board memory also supports accessing using the Ethernet logic and the remote address direct access logic.

Specifically, the image processor and the CPU are connected through the PCIe. The image processor typically provides at least two base address registers for the CPU to access itself. One is a VRAM Bar. After performing address mapping on this Bar, the CPU may directly read and write the content of a memory (referred to as VRAM, i.e., visible RAM) on the image processor through address access. The other is a register Bar. After performing address mapping on this Bar, the CPU may read and write various configurations in the image processor and operate various functions through this Bar, such as initiating data transmission, reading interrupting states, and restarting devices.

There are a plurality of modules in the image processor. An AI computing application program executes specific AI computing. MailBox is responsible for assisting other modules to communicate with the CPU. An MCU is responsible for restarting, power management, and other functions. A DMA data transmission module is responsible for accessing the host memory in the DMA manner. An address conversion unit is responsible for assisting other modules (such as an AI computing unit or the MCU) to convert a virtual address into a physical address and then access the memory on the field-programmable gate array board or the host memory.

The software running on the CPU may be divided into three major parts. A kernel mode driver has the highest system privileges and is responsible for memory management (including performing address mapping on all registers, allocating address segments of VRAM for various functions, creating page tables and writing them into the VRAM to assist the computing unit and MCU in the image processor to access the VRAM or host memory, etc.), writing necessary firmware to the image processor, assisting a user mode driver with address mapping, handling error interrupting, etc. The user mode driver acts as an intermediate layer and is responsible for providing an API (function call interface) to the application program, creating data streams (queues), initiating operations, assigning and mapping the VRAM (requiring the cooperation of the kernel mode driver), etc. The application program is located at the top layer and directly calls an ordinary glibc dynamic library and the API provided by the user mode driver to perform computing tasks required by the user.

In this embodiment, a data processing apparatus is further provided to implement the above-described embodiments and preferred implementations. Those that have already been described will not be repeated. As used hereinafter, the term “module” refers to a combination of software and/or hardware configured to perform a predetermined function. Although the apparatus described in the following embodiment is preferably implemented in software, implementations in hardware or a combination of software and hardware are also possible and contemplated.

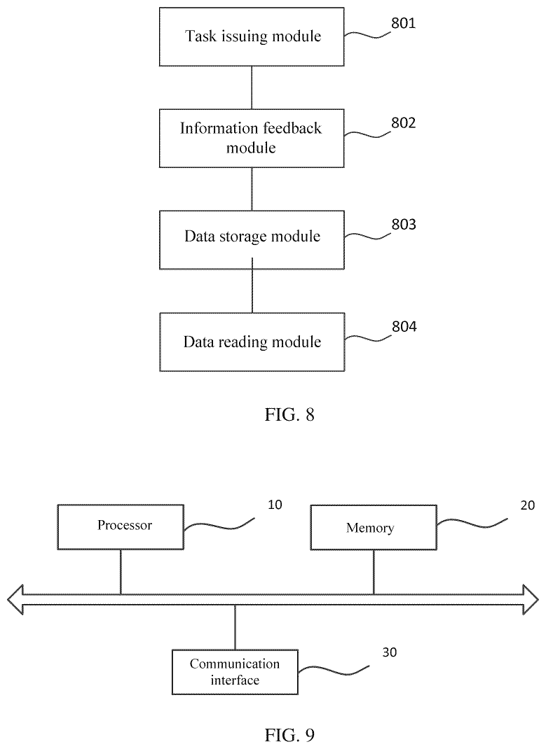

This embodiment provides a data processing apparatus, applied to a computing server. As shown in FIG. 8, the apparatus includes:
a task issuing module 801 configured to issue a target computing task to a computing device through a computing server, the target computing task including resource occupation information of to-be-computed source data and a remote direct address access request;
an information feedback module 802 configured to receive feedback information reported by the computing device based on the target computing task, the feedback information including a first storage address configured for storing the to-be-computed source data and a second storage address configured for storing computed result data which are allocated based on the remote direct address access request and the resource occupation information of the to-be-computed source data;
a data storage module 803 configured to store the to-be-computed source data in the first storage address based on the feedback information to cause the computing device to perform data computation based on the to-be-computed source data; and
a data reading module 804 configured to read, when receiving computation completion information reported by the computing device based on the to-be-computed source data, the computed result data from the second storage address.

The task issuing module 801 includes:
a connection establishment unit configured to cause the computing server to receive a connection request initiated by the computing device, and start a target computing program according to the connection request; and establish a connection between the computing server and the computing device through the target computing program, where the computing server stores a task cluster; and
a task issuing unit configured to acquire computing states of computing tasks in the task cluster; and issue the target computing task to the computing device based on the computing states and idle resource state information carried in the connection request.

Optionally, the task issuing unit includes:
a task selection subunit configured to select, based on the idle resource state information, the target computing task from computing tasks in a to-be-computed state;
an information acquisition subunit configured to acquire the resource occupation information of the to-be-computed source data in the target computing task; and
a task issuing subunit configured to issue the target computing task to the computing device based on the resource occupation information.

In some optical implementations, the information feedback module 802 includes:
a request acquisition unit configured to acquire a write request and a read request in the remote direct address access request;
a space allocation unit configured to allocate a data storage space and a result storage space to the to-be-computed source data based on the resource occupation information;
a first address generation unit configured to generate the first storage address based on the write request in the remote direct address access request and an address of the data storage space;
a second address generation unit configured to generate the second storage address based on the read request in the remote direct address access request and an address of the result storage space; and
a feedback information generation unit configured to generate the feedback information based on the first storage address and the second storage address.

In some optical implementations, the data storage module 803 includes:
a first area allocation unit configured to allocate, when the to-be-computed source data is not successfully stored in the first storage address allocated by the computing device, a first memory area with contiguous physical addresses in the computing server to the to-be-computed source data; and
a first information issuing unit configured to issue first address information of the first memory area to the computing device to cause the computing device to read the to-be-computed source data from the first memory area of the computing server based on the first address information and perform computation.

Optionally, the computing device further includes a first cache space and a second cache space. The first information issuing unit includes:
a first source data copying unit configured to cause the computing device to generate a reading request based on the first address information to request to copy the to-be-computed source data read from the computing server into the first cache space;
a first source data writing unit configured to write the to-be-computed source data in the first cache space into the data storage space based on the first storage address;
a second source data copying unit configured to copy, when space capacity of the first cache space in the computing device is insufficient, the to-be-computed source data into the second cache space; and
a second source data writing unit configured to write the to-be-computed source data in the second cache space in the computing device into the data storage space based on the first storage address.

In some optical implementations, the data storage module 803 is further configured to acquire a data volume of the to-be-computed source data in the first cache space and/or the second cache space in the computing device when writing the to-be-computed source data in the first cache space and/or the second cache space in the computing device into the data storage space based on the first storage address; and write, when the data volume of the to-be-computed source data is greater than a first data volume threshold, the to-be-computed source data in the first cache space and/or the second cache space into the data storage space based on the first storage address.

In some optical implementations, the data reading module 804 includes:
a first data reading unit configured to acquire the second storage address when the computation completion information reported by the computing device is received within a preset time; and read, based on the second storage address, the computed result data from the result storage space allocated by the computing device; and
a second data reading unit configured to allocate, if the computing server fails to receive the computation completion information reported by the computing device based on the to-be-computed source data within a preset time or fails to read the computed result data, a second memory area with contiguous physical addresses in the computing server to the computed result data; and issue second address information of the second memory area to the computing device to cause the computing device to write the computed result data into the second memory area of the computing server based on the second address information.

Optionally, the second data reading unit includes:
a write request acquisition subunit configured to cause the computing device to generate a writing request based on the second address information to request to cache the computed result data read from the result storage space in the first cache space;
a first result writing subunit configured to write the computed result data in the first cache space in the computing device into the second memory area based on the second address information;
a second result cache subunit configured to cache, when the space capacity of the first cache space in the computing device is insufficient, the computed result data in the second cache space; and
a second result writing subunit configured to write the computed result data in the second cache space in the computing device into the second memory area of the computing server based on the second address information.

In some optical implementations, the data reading module 804 is further configured to acquire a data volume of the computed result data in the first cache space and/or the second cache space in the computing device when writing the computed result data in the first cache space and/or second cache space into the second memory area based on the second address information; and write, when the data volume of the computed result data is greater than a second data volume threshold, the computed result data in the first cache space and/or second cache space into the second memory area based on the second address information.

In some optical implementations, the data reading module 804 is configured to determine next cache states of the first cache space and the second cache space based on a request type, the request type including a writing request and the reading request; and determine a result writing path of the computed result data and a data output path of the to-be-computed source data based on the next cache states, where the result writing path includes a first result writing path from the result storage space to the first cache space and/or the second cache space, and a second result writing path from the first cache space and/or the second cache space to a second memory space; and the data output path includes a first data output path from the first memory area to the first cache space and/or the second cache space, and a second data output path from the first cache space and/or the second cache space to the data storage space.

Optionally, when the next cache states of the first cache space and the second cache space are determined based on the request type, it is determined whether the next cache states of the first cache space and the second cache space are full states based on a writable space of the first cache space and the second cache space as well as the request type, and determined whether the next cache states of the first cache space and the second cache space are empty states based on to-be-computed source data and computed result data which are able to be outputted from the first cache space and the second cache space as well as the request type.

Further functional descriptions of the above-mentioned modules and units are the same as those in the above-mentioned corresponding embodiments, and will not be repeated here.

The data processing apparatus in this embodiment is presented in the form of a functional unit, and the unit here refers to an application specific integrated circuit (ASIC), a processor and a memory that executes one or more software or fixed programs, and/or other devices that may provide the above-mentioned functions.

The embodiments of the present application further provide a computer device including the above-mentioned data processing apparatus shown in FIG. 8.

Referring to FIG. 9, FIG. 9 is a schematic structural diagram of a computer device provided by an optical embodiment of the present application. As shown in FIG. 9, the computer device includes: one or more processors 10, memories 20, and interfaces configured to connect various components, including high-speed interfaces and low-speed interfaces. The various components are communicatively connected to each other using different buses, and may be installed on a common motherboard or otherwise as desired. The processor may process instructions executed within the computer device, including instructions stored in or on a memory to display graphical information of the GUI on an external input/output apparatus (such as a display device coupled to the interface). In some optical implementations, if desired, a plurality of processors and/or a plurality of buses may be used with a plurality of memories. Similarly, a plurality of computer devices may be connected, each providing some of the necessary operations (e.g., as a server array, a set of blade servers, or a multiprocessor system). FIG. 9 is described by taking a processor 10 as an example.

The processor 10 may be a CPU, a network processor, or a combination thereof. The processor 10 may further include a hardware chip. The above-mentioned hardware chip may be an ASIC, a programmable logic device, or a combination thereof. The above-mentioned programmable logic device may be a complex programmable logic device, a field-programmable gate array, a generic array logic, or any combination thereof.

The memory 20 stores an instruction executable by at least one processor 10 to cause the at least one processor 10 to perform the method illustrated in the above-mentioned embodiments.

The memory 20 may include a program storage region and a data storage region. The program storage region may store an application program required for an operating system and at least one function. The data storage region may store data created based on the usage of the computing device displaying a mini-program's landing page, and the like. In addition, the memory 20 may include a high-speed random access memory and a non-transient memory, such as at least one magnetic disk storage device, a flash memory device, or other non-transient solid-state storage devices. In some optical implementations, the memory 20 may optically include memories remotely located relative to the processor 10, and these memories may be connected to the computer device through a network. Examples of the above-mentioned network include, but are not limited to, the Internet, corporate intranets, server clusters, mobile communication networks, and combinations thereof.

The memory 20 may include a volatile memory, for example, a random access memory. The memory may further include a non-volatile memory, for example, a flash memory, a hard disk, or a solid-state hard disk. The memory 20 may further include a combination of the above-mentioned memories.

The computer device further includes a communication interface 30 for the computer device to communicate with other devices or communication networks.

The embodiments of present application further provide one or more non-volatile computer-readable storage media, storing a computer-readable instruction which, when executed by one or more processors, causes the one or more processors to perform the method according to the above-mentioned embodiments. The above-mentioned method according to the embodiments of the present application may be implemented in hardware or firmware, or as computer code that may be recorded in a storage medium, or as code originally stored in a remote storage medium or a non-transitory machine-readable storage medium and downloaded through a network and then stored in a local storage medium. Thus, the method described herein may be processed by such software stored on a storage medium using a general-purpose computer, a special-purpose processor, or programmable or special-purpose hardware. The storage medium may be a magnetic disk, an optical disk, a read-only memory, a random access memory, a flash memory, a hard disk, or a solid-state hard disk, etc. Further, the storage medium may further include a combination of the above-mentioned memories. It will be appreciated that a computer, processor, microprocessor controller, or programmable hardware includes a storage assembly that may store or receive software or computer code which, when accessed and executed by the computer, processor, or hardware, performs the method illustrated in the above-mentioned embodiments.

Although the embodiments of the present application have been described with reference to the accompanying drawings, various modifications and variations may be made by a person skilled in the art without departing from the spirit and scope of the present application, and these modifications and variations fall within the scope defined by the appended claims.

1. A data processing method, comprising:
issuing a target computing task to a computing device through a computing server, the target computing task comprising resource occupation information of to-be-computed source data and a remote direct address access request;
receiving feedback information reported by the computing device based on the target computing task, the feedback information comprising a first storage address configured for storing the to-be-computed source data and a second storage address configured for storing computed result data which are allocated based on the remote direct address access request and the resource occupation information of the to-be-computed source data;
storing the to-be-computed source data in the first storage address based on the feedback information to cause the computing device to perform data computation based on the to-be-computed source data; and
reading, in response to receiving computation completion information reported by the computing device based on the to-be-computed source data, the computed result data from the second storage address.

2. The method according to claim 1, further comprising generating the feedback information by the computing device, wherein the generating the feedback information by the computing device comprises:
acquiring a write request and a read request in the remote direct address access request;
allocating a data storage space and a result storage space to the to-be-computed source data based on the resource occupation information;
generating the first storage address based on the write request in the remote direct address access request and an address of the data storage space;
generating the second storage address based on the read request in the remote direct address access request and an address of the result storage space; and
generating the feedback information based on the first storage address and the second storage address.

3. The method according to claim 2, wherein the storing the to-be-computed source data in the first storage address based on the feedback information to cause the computing device to perform data computation based on the to-be-computed source data comprises:
acquiring, by the computing server, the first storage address configured for storing the to-be-computed source data; and
writing, based on the first storage address, the to-be-computed source data into the data storage space allocated by the computing device, and generating a computation instruction to cause the computing device to perform the data computation based on the to-be-computed source data.

4. The method according to claim 2, wherein the storing the to-be-computed source data in the first storage address based on the feedback information further comprises:
allocating, in response to the to-be-computed source data not being successfully stored in the first storage address allocated by the computing device, a first memory area with contiguous physical addresses in the computing server to the to-be-computed source data; and
issuing first address information of the first memory area to the computing device to cause the computing device to read the to-be-computed source data from the first memory area of the computing server based on the first address information and perform computation.

5. The method according to claim 4, wherein the computing device further comprises a first cache space, and the method further comprises reading the to-be-computed source data from the first memory area of the computing server based on the first address information, wherein the reading the to-be-computed source data from the first memory area of the computing server based on the first address information comprises:
generating, by the computing device, a reading request based on the first address information to request to copy the to-be-computed source data read from the computing server into the first cache space; and
writing the to-be-computed source data in the first cache space into the data storage space based on the first storage address.

6. The method according to claim 5, wherein the computing device further comprises a second cache space, and the method further comprises copying the to-be-computed source data read into the first cache space, wherein the copying the to-be-computed source data read into the first cache space comprises:
copying, in response to space capacity of the first cache space in the computing device being insufficient, the to-be-computed source data into the second cache space; and
writing the to-be-computed source data in the second cache space in the computing device into the data storage space based on the first storage address.

7. The method according to claim 2, wherein the reading the computed result data from the second storage address comprises:
acquiring the second storage address when the computation completion information reported by the computing device is received within a preset time; and
reading, based on the second storage address, the computed result data from the result storage space allocated by the computing device.

8. The method according to claim 6, wherein the reading the computed result data from the second storage address comprises:
allocating, in response to the computing server failing to receive the computation completion information reported by the computing device based on the to-be-computed source data within a preset time or failing to read the computed result data, a second memory area with contiguous physical addresses in the computing server to the computed result data; and
issuing second address information of the second memory area to the computing device to cause the computing device to write the computed result data into the second memory area of the computing server based on the second address information.

9. The method according to claim 8, further comprising writing the computed result data into the second memory area based on the second address information, wherein the writing the computed result data into the second memory area based on the second address information comprises:
generating, by the computing device, a writing request based on the second address information to request to cache the computed result data read from the result storage space in the first cache space; and
writing the computed result data in the first cache space in the computing device into the second memory area based on the second address information.

10. The method according to claim 9, further comprising caching the computed result data read from the result storage space in the first cache space, wherein the caching the computed result data read from the result storage space in the first cache space comprises:
caching, in response to the space capacity of the first cache space in the computing device being insufficient, the computed result data in the second cache space; and
writing the computed result data in the second cache space in the computing device into the second memory area of the computing server based on the second address information.

11. The method according to claim 6, wherein at least one of the writing the to-be-computed source data in the first cache space in the computing device into the data storage space based on the first storage address or the writing the to-be-computed source data in the second cache space in the computing device into the data storage space based on the first storage address comprises:
acquiring a data volume of the to-be-computed source data in at least one of the first cache space or the second cache space in the computing device; and
writing, in response to the data volume of the to-be-computed source data being greater than a first data volume threshold, the to-be-computed source data in the at least one of the first cache space or the second cache space into the data storage space based on the first storage address.

12. The method according to claim 10, wherein at least one of the writing the computed result data in the first cache space in the computing device into the second memory area based on the second address information or the writing the computed result data in the second cache space in the computing device into the second memory area based on the second address information comprises:
acquiring a data volume of the computed result data in at least one of the first cache space or the second cache space in the computing device; and
writing, in response to the data volume of the computed result data being greater than a second data volume threshold, the computed result data in the at least one of the first cache space or second cache space into the second memory area based on the second address information.

13. The method according to claim 8, further comprising:
determining next cache states of the first cache space and the second cache space based on a request type, the request type comprising a writing request and the reading request; and
determining a result writing path of the computed result data and a data output path of the to-be-computed source data based on the next cache states, wherein the result writing path comprises a first result writing path from the result storage space to at least one of the first cache space or the second cache space, and a second result writing path from at least one of the first cache space or the second cache space to the second memory area; and
the data output path comprises a first data output path from the first memory area to at least one of the first cache space or the second cache space, and a second data output path from at least one of the first cache space or the second cache space to the data storage space.

14. The method according to claim 13, wherein the determining the next cache states of the first cache space and the second cache space based on the request type comprises:
determining whether the next cache states of the first cache space and the second cache space are full states based on a writable space of the first cache space and the second cache space as well as the request type; and
determining whether the next cache states of the first cache space and the second cache space are empty states based on to-be-computed source data and computed result data which are able to be outputted from the first cache space and the second cache space as well as the request type.

15. The method according to claim 1, wherein before the issuing the target computing task to the computing device, the method further comprises:
receiving, by the computing server, a connection request initiated by the computing device, and starting a target computing program according to the connection request; and
establishing a connection between the computing server and the computing device through the target computing program.

16. The method according to claim 15, wherein the computing server stores a task cluster, and the issuing the target computing task to the computing device comprises:
acquiring computing states of computing tasks in the task cluster; and
issuing the target computing task to the computing device based on the computing states and idle resource state information carried in the connection request.

17. The method according to claim 16, wherein the issuing the target computing task to the computing device based on the computing states and the idle resource state information carried in the connection request comprises:
selecting, based on the idle resource state information, the target computing task from computing tasks in a to-be-computed state;
acquiring the resource occupation information of the to-be-computed source data in the target computing task; and
issuing the target computing task to the computing device based on the resource occupation information.

18. (canceled)

19. A data processing system, comprising: a computing server and a computing device,
the computing server being configured to issue a target computing task to the computing device, the target computing task comprising resource occupation information of to-be-computed source data and a remote direct address access request;
the computing device being configured to report feedback information based on the target computing task, the feedback information comprising a first storage address configured for storing the to-be-computed source data and a second storage address configured for storing computed result data which are allocated based on the remote direct address access request and the resource occupation information of the to-be-computed source data; and
the computing server being further configured to store the to-be-computed source data in the first storage address based on the feedback information, and read, in response to receiving computation completion information reported by the computing device based on the to-be-computed source data, the computed result data from the second storage address.

20. (canceled)

21. A computer device, comprising:
a memory and a processor, the memory and the processor being communicatively connected to each other, the memory storing a computer-readable instruction, and the processor, when executing the computer-readable instruction, configured to:
issue a target computing task to a computing device through a computing server, the target computing task comprising resource occupation information of to-be-computed source data and a remote direct address access request;
receive feedback information reported by the computing device based on the target computing task, the feedback information comprising a first storage address configured for storing the to-be-computed source data and a second storage address configured for storing computed result data which are allocated based on the remote direct address access request and the resource occupation information of the to-be-computed source data;
store the to-be-computed source data in the first storage address based on the feedback information to cause the computing device to perform data computation based on the to-be-computed source data; and
read, in response to receiving computation completion information reported by the computing device based on the to-be-computed source data, the computed result data from the second storage address.

22. One or more non-volatile computer-readable storage media, storing a computer-readable instruction which, when executed by one or more processors, causes the one or more processors to perform steps of the method according to claim 1.
